(19) United States
(12) Patent Application Publication
(10) Pub. No.: US 2008/0021946 A1
(43) Pub. Date: Jan. 24, 2008

(54) Polyphase Interpolating Filter With Noise Shaping Modulator

(75) Inventor: Frans Victor Felix De Buys, Leuven (BE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V., Eindhoven (NL)

(21) Appl. No.: 11/631,403

(22) PCT Filed: Jun. 24, 2005
(86) PCT No.: PCT/IB05/52100

§ 371 Date: Dec. 29, 2006

(30) Foreign Application Priority Data
Jun. 29, 2004 (EP) 04103016.4

(51) Int. Cl. G06F 17/17

(52) U.S. Cl. 708/313

(57) ABSTRACT

A polyphase filtering method and a polyphase filter is described having N polyphase branches, which receives input samples, an a single branch of the polyphase filter is selected for an interpolation of an input sample. A noise shaping modulator is used for noise shaping the output of the filter to thereby reduce the noise error introduced by selecting only the one single branch of the polyphase filter. The advantages of the filter and method according to the present invention are: The system can be cheaper to implement, depending on the order of the noise shaper needed to obtain sufficient performance. The system can have the same performance as conventional systems with lower over sampling factors, due to the lack of a linear distribution, and as such use less memory.

The present invention relates a method and apparatus for a polyphase interpolating filter with a noise shaping modulator as can be used, for example in a sample rate converter.

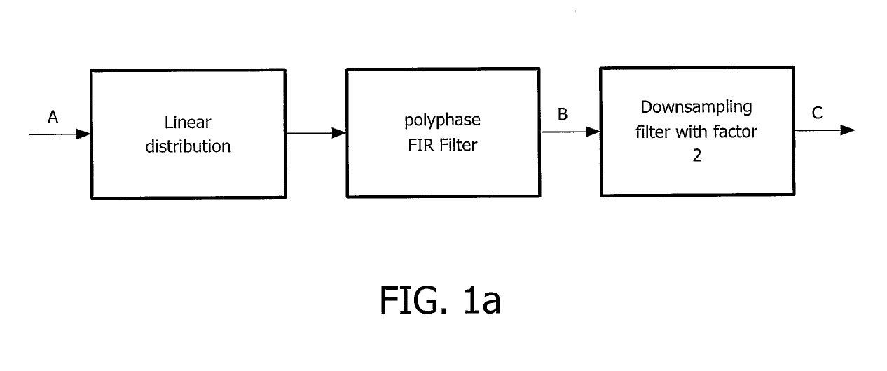

FIG. 1a shows the high-level block diagram of a down sampling sample rate conversion system and FIG. 1b shows some signals at the points indicated with A, B and C. Polyphase sample rate converters are known from U.S. Pat. No. 6,411,225. The polyphase FIR filter consists of a number of polyphase branches. Depending on the position of an input sample with respect to the closest two output samples, two polyphase branches will be selected. The position of the input sample with respect to the two selected branches (δ) will be used as a linear distribution factor between the two polyphase branches. In other words, an incoming sample with amplitude L is linearly distributed between the two selected branches. The two resulting samples will each be filtered by one of the selected branches of the polyphase FIR filter. The samples coming out of this filter will be down sampled with a factor of two and this is the output of the algorithm.

The time grid on which an output sample is calculated has a limited resolution (Tᵢₙ/polyphase branches). If the number of polyphase branches is increased, the time grid will get smaller. In the limit, there is no need anymore for calculating two branches, but the number of filter coefficients will be very large. For example, the AD1985 asynchronous sample rate converter supplied by Cirrus Logic, Austin Tex. uses 2²⁰ branches.

An object of the present invention is to improve method and apparatus for a polyphase interpolating filter with a noise shaping modulator as can be used, for example in a sample rate converter.

The present invention is based on the finding that the for a polyphase filter calculation of two filter branches for every sample coming in followed by linear distribution is not necessary provided noise shaping is utilized for suppressing or reducing noise introduced because of selecting only one filter branch.

The above objective is accomplished by a method and device according to the present invention.

The present invention provides a polyphase filter having N polyphase branches, the filter comprising:

means for receiving input samples,

control means for selecting a single branch of the polyphase filter for an interpolation of an input sample, and

a noise shaping modulator for noise shaping the output of the filter to thereby reduce the noise error introduced by selecting only the one single branch of the polyphase filter. The noise shaping modulator can be first order or a higher order than first order. The noise shaping modulator can be a single stage noise shaping modulator or a multi-stage noise shaping modulator.

The present invention also includes the use of a polyphase filter according to any of the above claims in a sample rate converter.

The present invention also includes a method of polyphase filtering with N polyphase branches, the method comprising:

receiving input samples,

selecting a single branch of the polyphase filter for an interpolation of an input sample, and

noise shaping the output of the filter to thereby reduce the noise error introduced by selecting only the one single branch of the polyphase filter.

The present invention also includes a software product comprising code segments which when executed on a processing engine provide a polyphase filter having N polyphase branches, software product comprising code segments which provide:

means for receiving input samples,

control means for selecting a single branch of the polyphase filter for an interpolation of an input sample, and

a noise shaping modulator for noise shaping the output of the filter to thereby reduce the noise error introduced by selecting only the one single branch of the polyphase filter. The software may be stored on a machine readable data carrier Such as a CD-ROM, DVD-ROM, diskettes, hard disc, solid state memory, tape storage, etc.

The advantages of the system and method according to the present invention are:

The system can be cheaper to implement, depending on the order of the noise shaper needed to obtain sufficient performance.

The system can have the same performance as conventional systems with lower over sampling factors, due to the lack of a linear distribution, and as such use less memory.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference numbers quoted below refer to the attached drawings.

FIG. 1a is a schematic block diagram of a known polyphase filter.

FIG. 1b shows the selection of two polyphase branches and linear distribution between them.

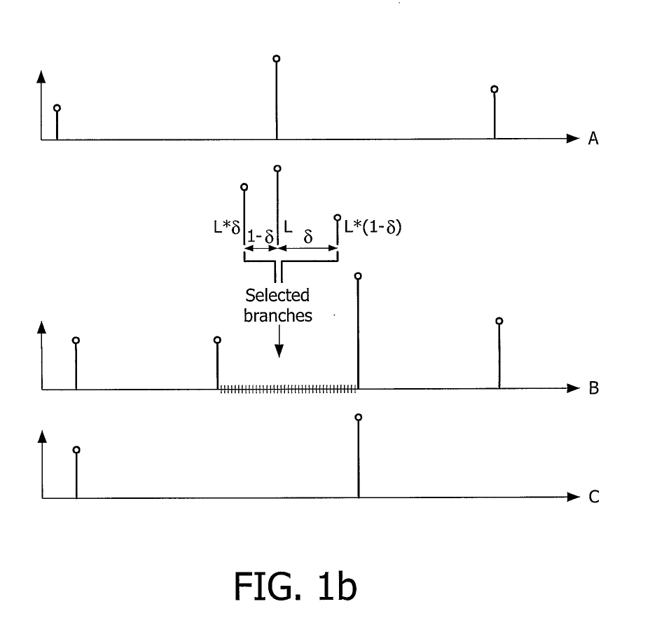

FIG. 2 is a spectrum of a signal from the polyphase filter of FIG. 1.

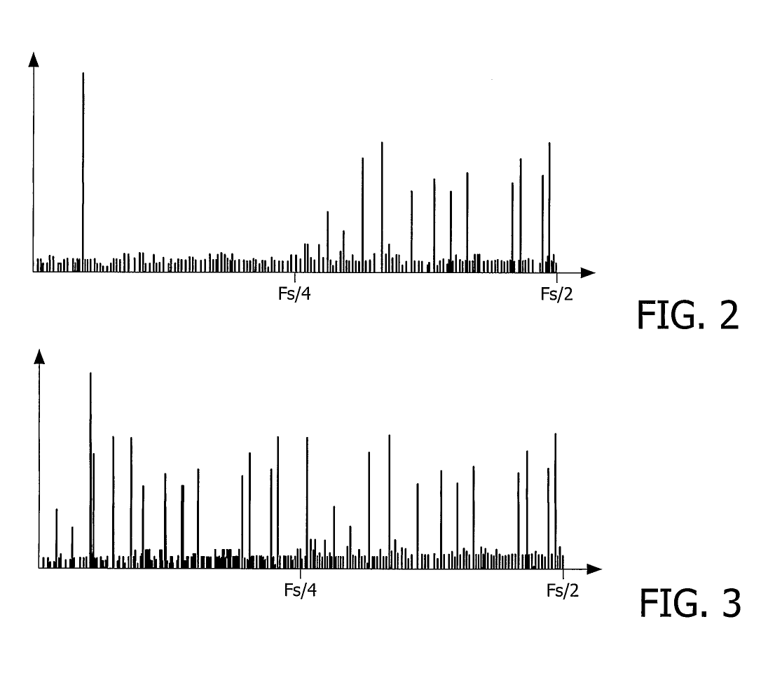

FIG. 3 shows a spectrum when only one branch of the polyphase filter is calculated and selected.

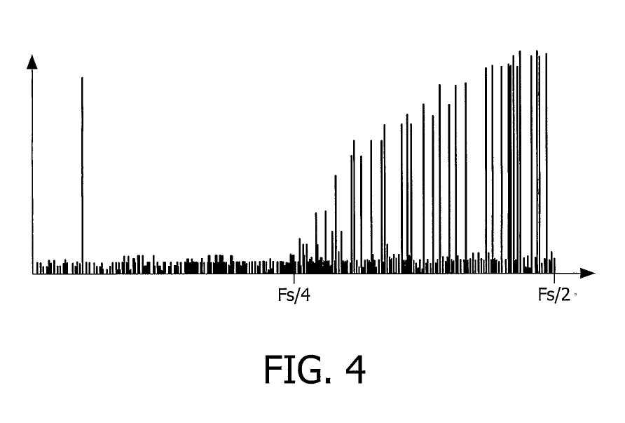

FIG. 4 shows a spectrum when only one branch of the polyphase filter is calculated and selected and the output is noise shaped in accordance with an embodiment of the present invention.

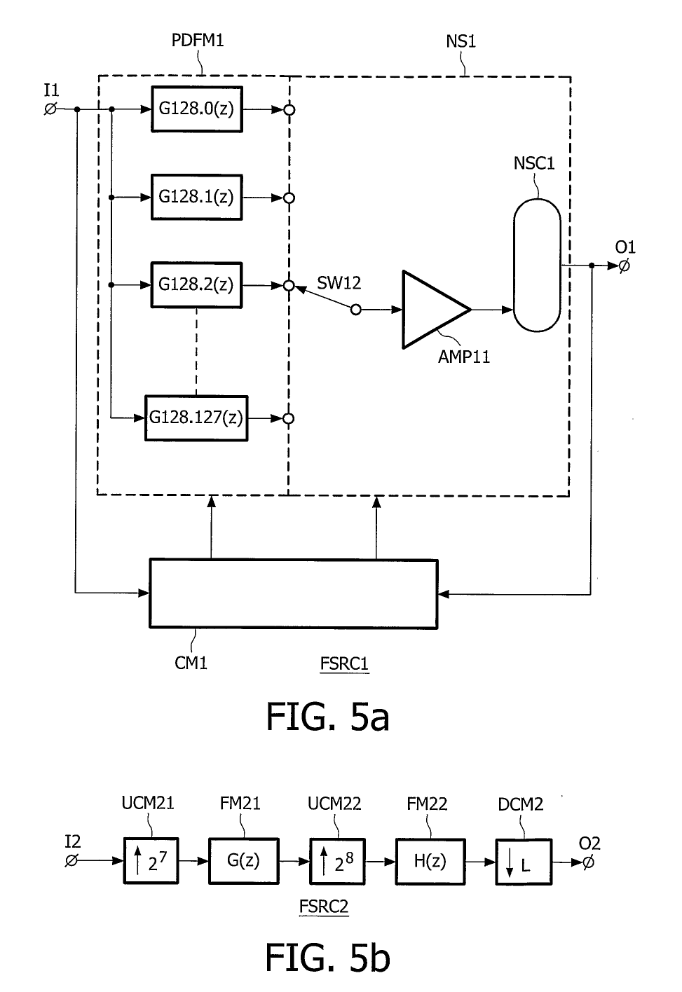

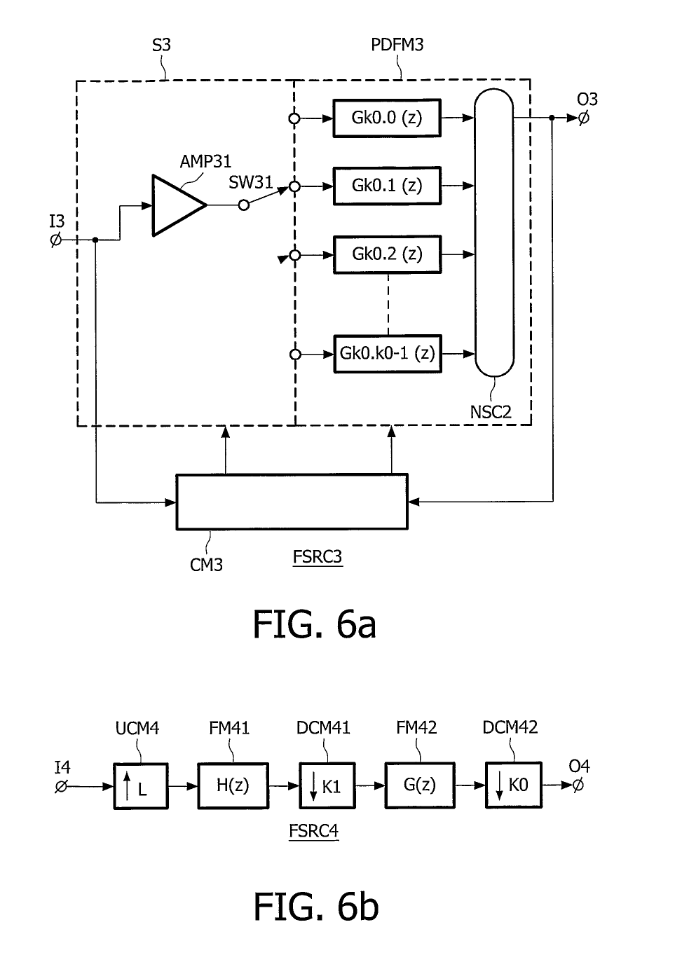

FIGS. 5a, 5b and FIGS. 6a, 6b show schematic block diagrams of two types of sample rate converter, respectively in accordance with embodiments of the present invention

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

The present invention is based on the finding that the calculation of the two filter branches for every sample coming in to a polyphase filter followed by linear distribution is not necessary. The spectrum of a sine wave signal at the input when it comes out of the polyphase FIR filter at point B (see FIG. 1) will look as in FIG. 2. In this figure the sine wave peak and the strongly attenuated aliases and noise below Fs/4 and some aliases above Fs/4 can be seen. The part above Fs/4 can be ignored because this part will be filtered away by the down sampling filter with a factor of two. When the system is changed in such a way that the controller of the polyphase filter selects only one branch to be used for the calculations for each input sample entering the system, the spectrum of the signal at point B will look as FIG. 3 due to the limited time resolution. There is a lot of unwanted signal in the spectrum below Fs/4.

In one aspect of the present invention the branch is calculated in a noise shaped way, i.e. by the addition of a noise shaping modulator. Noise shapers are commonly used to solve problems due to limited amplitude resolution. For example, quantization noise in data converters such as analog to digital converters can be reduced by means of noise shaping, see for example the book by R. J. Baker “CMOS mixed signal circuit design”, vol. 11, especially chapter 22, Wiley Interscience, 2002. Contrary to this known application, noise shaping is used in accordance with an aspect of the present invention to solve problems due to limited time resolution of the selection of the polyphase branches. Thus, in accordance with this aspect the polyphase branches are treated as determining a form of temporal quantization. Selection of only one branch introduces a temporal quantization error. This temporal quantization error is then removed or reduced by noise shaping. The principle of noise shaping using a noise shaping modulator is to feedback either the signal itself or the error signal from an integrator. The integrator typically has a signal transfer function defined by:

$$STF ( z ) = \frac{{z}^{- 1}}{1 - {z}^{- 1}}$$

for a frequency z. The effect of a noise modulator is to high pass filter the noise whereas the data signal is only delayed. The result is to move the temporal quantization noise power introduced by selecting only one polyphase branch outside the signal band. The spectrum of the noise shaped output at point B looks as in FIG. 4. The noise in the spectrum below Fs/4 is sufficiently attenuated again. Any suitable noise modulator may be used. For example, the noise modulator may be first or higher order and may be a single or multi-stage modulator.

The advantages of the system and method according to the present invention are:

The system can be cheaper to implement, depending on the order of the noise shaper needed to obtain sufficient performance.

The system can have the same performance as conventional systems with lower over sampling factors, due to the lack of a linear distribution, and as such use less memory.

FIG. 5a shows schematically a first example of an asynchronous sample rate converter FSRC1 embodied as an up-converter which can be used with the present invention having an input I1 and an output O1. There is no linear distribution unit. The sample rate converter can be embodied in software, in hardware or in a combination of the two. This sample rate converter comprises, logically, a series-arrangement of polyphase decomposition filter means PDFM1 and noise shaping means NS1. The term “logically” implies that the physical arrangement does not need to be one after another in space, e.g. if the converter is implemented in software. Further the sample rate converter comprises control means CM1 that control the operation of the polyphase decomposition filter means PDFM1 and the noise shaping means NS1. The sample rate converter FSRC1 may be a flexible sample rate converter. In this context the word “flexible” means that the actual ratio between the input and output sampling frequencies (called the conversion ratio N) does not have to be known in advance. Instead, the required amount of suppression of the images created in the conversion process has to be known. These images may lead to unwanted aliasing. This information and the relative bandwidth are needed to design the interpolating filters.

The polyphase decomposition filter means PDFM1 comprises in this example 128 polyphase branches (G128,0 (z)-G128,127 (z)). In this example only one output of the polyphase branches is coupled to a switch SW1 feeding the noise shaping means NS1. The noise shaping means NS1 may further comprise an amplifier AMP11, whereby the amplifier AMP11 amplifies the received signal without a factor delta as is conventional when the amplifier is part of a linear interpolator.

The output of the amplifier is coupled to a noise shaping circuit NSC1 that supplies the noise shaped signal to the output O1 of the sample rate converter FSRC1. The control means CM1 determines which sample from the polyphase filter is passed to the noise shaping circuit NSC1. The circuit elements, e.g. switches, control means, interpolator, amplifiers etc. can be implemented in software, hardware or a combination of the two.

FIG. 5b shows a functional example of an asynchronous sample rate converter FSRC2 which can be used with the present invention as an up-converter. There is no linear distribution unit. The sample rate converter comprises, logically, in this example, a series-arrangement of first up-conversion means UCM21, first filter means FM21, second up-conversion means UCM22, second filter means FM22 and down conversion means DCM2. The sample rate converter can be embodied in software, in hardware or in a combination of the two. The term “logically” implies that the physical arrangement does not need to be one after another in space, e.g. if the converter is implemented in software. By splitting the up-conversion in two stages with filter means in between the efficiency of the sample rate converter is improved. The transition band oft he first filter means can be chosen very narrow and the transition band of the second filter means can be chosen very broadly.

FIG. 6a shows a practical example of an asynchronous sample rate converter as a down-converter FSRC3 having an input I3 and an output O3 which can be used with the present invention. There is no linear distribution unit. This sample rate converter comprises, logically, a series-arrangement of a switch means S3 and polyphase decomposition filter means PDFM3 having Ko branches (Gko,0 (z)-Gko,Ko−1 (z)) with a noise shaping circuit NSC2. Further, the sample rate converter comprises control means CM3 for controlling the operation of the switch means and the polyphase decomposition filter means. The sample rate converter can be embodied in software, in hardware or in a combination of the two. The term “logically” implies that the physical arrangement does not need to be one after another in space, e.g. if the converter is implemented in software. The circuit elements, e.g. switches, control means, interpolator, amplifiers etc. can be implemented in software, hardware or a combination of the two.

The sample rate converter according to this example, as down-converter, is the transposed version of the sample rate converter up-converter of FIG. 5a.

The polyphase decomposition filter means PDFM3 comprises in this example 128 polyphase branches (G128,0 (z)-G128,127 (z)). In this example only one output of the polyphase branches which has been selected by the switch means SW31 is coupled to the noise shaping circuit NSC2. The switch means S3 may further comprise an amplifier AMP31, whereby the amplifier AMP31 amplifies the received signal without a factor delta as is conventional when the amplifier is part of a linear interpolator.

One selected output of the polyphase filter is coupled to a noise shaping circuit NSC2 that supplies the noise shaped signal to the output O3 of the sample rate converter FSRC3. The control means CM1 determines which sample is passed to the noise shaping circuit NSC2. The circuit elements, e.g. switches, control means, interpolator, amplifiers etc. can be implemented in software, hardware or a combination of the two.

FIG. 6b shows a functional example of an asynchronous sample rate converter as a down-converter FSRC4 which can be used with the present invention. There is no linear interpolation unit. The converter comprises an input I4 and an output O4 and a logical series-arrangement of up-converting means UCM4, first filter means FM41, first down-conversion means DCM41, second filter means FM42 and second down-conversion means DCM42 is placed. The factors can be chosen as required, whereby Ko and K1 are fixed integers and L<=Ko*K1. The sample rate converter can be embodied in software, in hardware or in a combination of the two. The term “logical” implies that the physical arrangement does not need to be one after another in space, e.g. if the converter is implemented in software. The circuit elements, e.g. switches, control means, interpolator, amplifiers etc. can be implemented in software, hardware or a combination of the two.

The present invention also includes software for implementing a polyphase interpolating filter in accordance with the present invention. The software code, when executed on a processing engine such as a microprocessor or a programmable gate array (such as an FPGA) or similar comprises means for receiving input samples, selecting a single branch of the polyphase filter for an interpolation of an input sample, and means for noise shaping the output of the filter to thereby reduce the noise error introduced by selecting only the one single branch of the polyphase filter. The software may be stored on any suitable machine readable storage device such as diskettes, tape storage, optical disk storage such as CD-ROM or DVD-ROM solid state memory, etc.

1. A polyphase filter having N polyphase branches, the filter comprising:
means for receiving input samples
control means for selecting a single branch of the polyphase filter for an interpolation of an input sample, and
a noise shaping modulator for noise shaping the output of the filter to thereby reduce the noise error introduced by selecting only the one single branch of the polyphase filter.

2. The polyphase filter according to claim 1, wherein the noise shaping modulator is first order.

3. The polyphase filter of claim 1, wherein the noise shaping modulator is a higher order than first order.

4. The polyphase filter according to claim 1, wherein the noise shaping modulator is a single stage noise shaping modulator.

5. The polyphase filter according to claim 1, wherein the noise shaping modulator is a multi-stage noise shaping modulator.

6. Use of a polyphase filter according to claim 1 in a sample rate converter.

7. The use according to claim 6, for an upconverter or a downconverter.

8. A method of polyphase filtering with N polyphase branches, the method comprising:
receiving input samples,
selecting a single branch of the polyphase filter for an interpolation of an input sample, and
noise shaping the output of the filter to thereby reduce the noise error introduced by selecting only the one single branch of the polyphase filter.

9. A software product comprising code segments which when executed on a processing engine provide a polyphase filter having N polyphase branches, software product comprising code segments which provide:
means for receiving input samples,
control means for selecting a single branch of the polyphase filter for an interpolation of an input sample, and
a noise shaping modulator for noise shaping the output of the filter to thereby reduce the noise error introduced by selecting only the one single branch of the polyphase filter.

10. A machine readable data carrier storing the software product of claim 9.
